(19) United States
(12) Patent Application Publication
(10) Pub. No.: US 2006/0121150 A1
(43) Pub. Date: Jun. 8, 2006

(54) Mold core of an injection molding tool

(76) Inventors: Werner Plass, Eschborn (DE); Manfred Lausenhammer, Konz Niedermennig (DE)

Correspondence Address: SIMPSON & SIMPSON, PLLC, 5555 MAIN STREET, WILLIAMSVILLE, NY, 14221-5406, US

(21) Appl. No.: 10/524,312

(22) PCT Filed: May 20, 2003
(86) PCT No.: PCT/DE03/01630

§ 371 Date: Oct. 5, 2005

(30) Foreign Application Priority Data
Aug. 9, 2002 (DE) 102 36 522.9

(51) Int. Cl. B29C 49/00

(52) U.S. Cl. 425/533

(57) ABSTRACT

A mold core of an injection molding tool for the injection molding of preforms of plastic material. The mold core is in the form of a hollow casing which is closed at one end, with a central axis, an outer surface, an inner surface and a hollow cooling tube. The hollow tube is arranged in the mold core at a spacing from the inner surface and is in communication with coolant feed conduits and coolant discharge conduits. The cooling tube extends coaxially with respect to the mold core over almost the entire length thereof and is provided at the downstream end with an outlet opening and cooling grooves are provided on the inner surface of the mold core.

### BACKGROUND OF THE INVENTION

The invention concerns a mold core of an injection molding tool for the injection molding of preforms of plastic material, wherein the mold core is in the form of a hollow casing which is closed at one end, with a central axis, an outer surface, an inner surface and a hollow cooling tube which is arranged in the mold core at a spacing from the inner surface thereof, in communication with coolant feed conduits and coolant discharge conduits.

It is known for bottles of more or less transparent plastic material to be blown from preforms, in particular the known PET bottles (PET=polyethylene terephthalate). Preforms of PET are produced in large numbers in powerful injection molding machines. Those preforms usually have relatively thick walls, normally from 1.5 mm to 4.0 mm. They are shaped by injection molding at relatively high temperatures of between about 260° C. and 310° C. The hollow preforms which are closed at one end, after the injection molding operation, are cooled on the one hand on the mold core and on the other hand also after removal from the injection molding machine in order to prevent deformation thereof or to prevent them from sticking together. Their thick walls act like a heat insulator which retains the heat in the wall.

In order to increase the manufacturing output of the known injection molding machines, the attempt is made to reduce the cooling time, with the disadvantage that here it is not possible to go below a lower limit, without tolerating damage to the preforms after the injection molding procedure.

Cooling of the surface of the injection molded preforms must be sufficient to permit them to be ejected without damage from the injection molding mold. Furthermore additional cooling is necessary in order also to remove the heat which passes to the surface from the interior of the walls. If cooling in the injection molding machine after the injection molding operation and in respect of the preforms after the removal thereof from the machine is omitted, the temperature of the surface rises in an undesirable manner and has the result that the injection molded preforms stick to each other, become susceptible to damage to the surface, bend or distort. Measures are therefore repeatedly provided to improve cooling of the injection-molded preforms.

In practice therefore the attempt has been made for example to cool the outer tool portion surrounding the preform on the outside thereof, as well as the mold core. It has been found that the preform shrinks inwardly on to the core a short time after its injection molding operation, with the consequence that there is a narrow gap between the outer tool portion and the product itself, the preform, and that narrow gap then causes considerable difficulties in terms of the transfer of heat from the outer cooled tool portion to the preform and makes cooling practically ineffective. Therefore attention has been directed to an increased extent to cooling of the mold core. In practice a cooling tube has been fitted into the mold core in such a way that it occupies practically the entire internal space of the mold core with the exception of an annular space in the form of a gap around the cooling tube, and within the inner surface of the mold core. Coolant, preferably water, has been introduced into the cooling tube through feed conduits connected to the open lower end of the cooling tube and the water is caused to coolingly wet the inner surface of the mold core, after which the water is carried away through discharge conduits. In actual fact it was possible for the mold core to be cooled to some extent over the inner surface thereof. It was realised however that this cooling could be still further improved and thus the total production of preforms improved and in particular it could be made more powerful.

### BRIEF DESCRIPTION OF THE DRAWINGS

FIG. 1 is a view in cross-section of a mold core with the forwardly arranged, thinner region and the rearwardly arranged feed and discharge conduits, and

FIG. 2 is a broken-away view on a greatly enlarged scale showing the detail II indicated by the circle II in FIG. 1.

### BRIEF DESCRIPTION OF THE INVENTION

Therefore the object of the present invention is to provide a mold core of the kind set forth in greater detail in the opening part of this specification and the cooling effect of which is substantially increased in comparison with mold cores which have been previously used.

The invention therefore comprises a mold core of an injection molding tool for the injection molding of preforms of plastic material. The mold core is in the form of a hollow casing which is closed at one end, with a central axis, an outer surface, an inner surface and a hollow cooling tube. The hollow tube is arranged in the mold core at a spacing from the inner surface and is in communication with coolant feed conduits and coolant discharge conduits. The cooling tube extends coaxially with respect to the mold core over almost the entire length thereof and is provided at the downstream end with an outlet opening and cooling grooves are provided on the inner surface of the mold core.

### DETAILED DESCRIPTION OF THE INVENTION

According to the invention that object is attained in that the cooling tube extends coaxially with respect to the mold core over almost the entire length thereof and is provided at the downstream end with an outlet opening, and that provided on the inner surface of the mold core are cooling grooves extending substantially transversely with respect to the central axis. As in the practice already involved in operation, the cooling tube extends practically into the entire internal space of the mold core and ends only ‘at the front’ at the closed end of the mold core shortly before the end of the internal space, in such a way that the cooling water which flows through the cooling tube can leave it at its front end by way of an opening in the cooling tube and can pass against the inner surface of the mold core. The mold core is closed in a blind configuration at the front and its inner surface forms the outside wall of the coaxial annular space in the form of a gap between the cooling tube and the mold core. Behind, that is to say downstream of the cooling water, that annular space is connected to the above-mentioned coolant discharge conduit.

The mold core is admittedly cooled to a certain degree by the contact of the cooling water with its inner surface, but in accordance with the invention that cooling effect can be improved on the one hand by the inner surface of the mold core being enlarged. That is achieved by cooling ribs being additionally provided in the otherwise closed inner surface of the mold core. In a particularly desirable fashion and surprisingly however the cooling effect is enhanced additionally on the other hand by virtue of the fact that the cooling grooves or cooling ribs disposed on the inner surface of the mold core extend not only lengthwise but extend transversely with respect to the central axis. ‘Transversely’ denotes perpendicularly only in a specific case, the direction in which the respective cooling groove extends can also be envisaged as being inclined with respect to the central axis of the mold core. The cooling grooves also do not need to follow a straight line along the path along which they extend, but they can extend in a wavy configuration or curved in any fashion. It should only be noted that the predominant part of the cooling grooves do not extend in the direction of the central axis but set at an angle with respect thereto.

It has been found more specifically that in operation cooling grooves extending ‘transversely’ with respect to the central axis have a correspondingly transverse afflux flow thereagainst, with the consequence that the coolant is subjected to not inconsiderable turbulence effects on its way after leaving the cooling tube from the opening at the front rearwardly along the annular space in the form of the gap. The cooling effect of the respective mold core was therefore admittedly already enhanced by virtue of an increase in surface area, insofar as the otherwise smooth, closed inner surface of the mold core is enlarged, that is to say, it now has ribs, channels, grooves or the like; on the other hand however turbulence effects occur in the flow of coolant along the course of its flow path, and it is precisely those turbulence effects which considerably increase the cooling effect.

In a further advantageous configuration of the invention the cooling grooves are of a pointed and/or round profile in cross-section. The term profile is used here to denote the cross-section through a cooling groove, which cross-section can be ‘round’, like for example the bottom of a U; or it can be ‘pointed’, like the lower end of a pointed V. If for example consideration is given to a V-shaped profile with two sides which intersect at an acute angle, then it can be particularly preferable for that angle to be selected from the range of between 10° and 70°, preferably from the range of between 20° and 50°, or for it to be selected at 40°. Those details do not signify that the angle of the profile in question must be in those ranges. Those details only signify that successful tests have already been carried out in practice with such angles.

Instead of the sides in the case of ‘pointed’ profiles, it is also possible to use arcuate surfaces for the production of round profiles, as are known for example in the case of round screwthreads.

Thus it is also desirable if in accordance with the invention the cooling grooves extend in a helical configuration. In other words the cooling grooves extend like a screwthread. The screwthread can involve any kind of geometry, provided only that the smooth surface area, if no cooling grooves were provided, is enlarged. The cooling grooves, with their radial geometry, can preferably be in the form of a trapezoidal screwthread or a sawtooth screwthread. It is desirable to adopt a radial geometry for increasing surface area and producing turbulence phenomena. From the point of view of production engineering it is also desirable if the cooling grooves extend in a round configuration. Practical tests have already afforded advantageous production if rings, channels, screwthreads or all those configurations are used together. As a result the water flowing by way of those cooling grooves is subjected to severe swirling and eddy effects with the consequence of good turbulence and thus a great cooling effect.

A particularly radical improvement in the cooling effect is afforded if, in accordance with the invention, the cooling grooves extend over those surface regions of the mold core, on which the preform is injected. Provided in the rear region of the mold core are conduits and holders so that the preform to be injected is kept away from that rear region of the mold core. Therefore, there is also no need to provide there a special feature for cooling. In accordance with the invention however the cooling grooves are provided in the entire surface region, that is to say the region of the outer surface of the mold core on which the plastic material of the injected preform rests and with which it is in contact. In accordance with the invention the cooling grooves are provided at least over that surface region on which the preform is injected. In that respect it is not impossible that the in part thicker regions of the holder of the mold core can also be provided with cooling grooves. However surprising success in terms of increasing the cooling effect has already now been attained if cooling ribs are provided solely in the region of the preform resting on the mold core, on the inner surface of the mold core.

In the practical context of operation which has already been conducted with the described mold core provided at the front end of the cooling tube is an outlet opening. The cooling water issues therefrom and leaves the mold core rearwardly, after flowing through the annular space in the form of a gap. If now in addition the outlet opening on the cooling tube has at least one recess or cut-out extending in the direction of the central axis, it is additionally found that the cooling water issues from the cooling tube more easily. In the simplest case the outlet opening at the front end of the cooling tube can be envisaged in such a way that it is theoretically cut off the closed cooling tube so that the surface of the outlet opening is disposed perpendicularly to the central axis of the mold core. The outer edge of such an outlet opening would then be circular. If now that circular edge is provided with an additional cut-out which extends at least partly in a direction towards the central axis of the cooling tube, the area of the outlet opening is increased, with the result that the cooling water can there issue more easily into the annular space in the form of the gap. Such a cut-out at the edge of the outlet opening can be envisaged as being of a V-shaped or U-shaped configuration or of some other profile provided that the edge follows not only the circular line but is increased in length by the above-mentioned cut-out.

When the cooling water flows out of the outlet opening of the cooling tube, the intention is to provide the main throttling effect in the course of the flow path in that region of the gap-shaped annular space in which the preform is externally injected on to the outer surface. Further rearwardly the coolant discharge conduits can even be of larger cross-sections so that the coolant is allowed to expand there. There, in the rear region, at a relatively great distance from the injected preform, there is no longer any need for cooling, a turbulence effect and therefore also large surface areas. There the coolant can flow away rearwardly smoothly and in an expanded relaxed condition without resistance.

Further advantages, features and possible uses of the present invention will be apparent from the description hereinafter of a preferred embodiment with reference to the accompanying drawings.

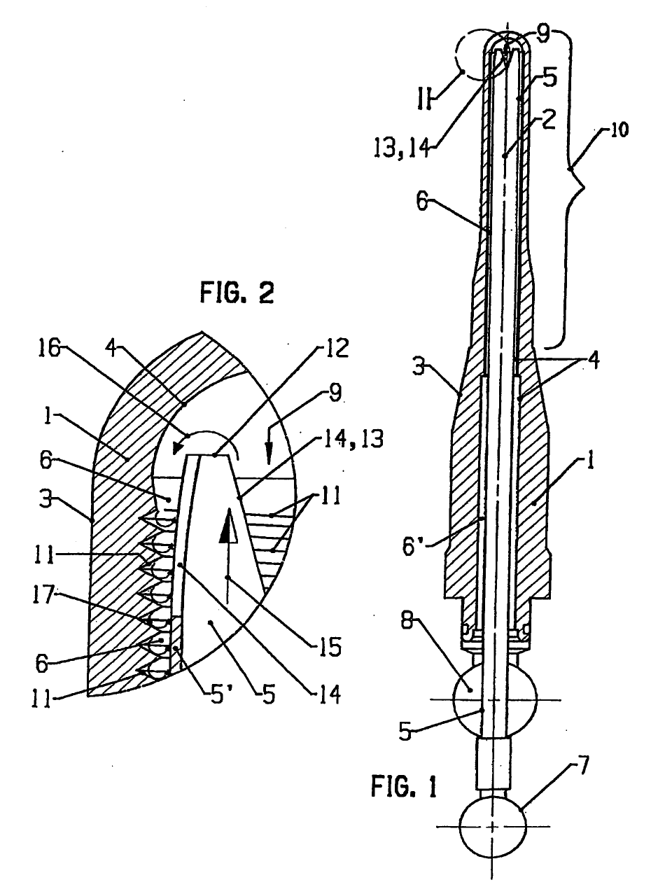

The preferably titanium-plated mold core has the thicker region which is shown rearwardly in FIG. 1 (that is to say downwardly) for mounting for example in a core plate while at the front it has the thinner region 10 over which the preform (not shown) is held open after the injection operation. The wall (shown in broken line) of the mold core 1 is in the configuration (at the top in FIGS. 1 and 2) of a closed hollow casing with the central axis 2 shown in dash-dotted line. The mold core 1 has an outer surface 3 and an inner surface 4.

At a spacing from the inner surface 4 of the mold core 1 it is almost entirely provided with a cooling tube 5. An annular space 6 in the form of a gap is formed on the exterior between the inner surface 4 of the mold core 1 and the cooling tube 5. In the front region on which in operation the preform is injected, the annular space 6 is in the form of a gap, that is to say radially it is of a small dimension of between preferably 1.5 mm and 3 mm, depending on the available space. As a result, in the ideal case, that gives an 80% damming accumulation effect, that is to say, the discharge flow is 80% of the feed flow. In contrast the radial extent of the rear annular space 6′ which is in the thicker holding region of the mold core 1 is provided only for the discharge flow of coolant in an expanded condition.

The lower region of FIG. 1 shows the coolant feed conduit 7 which can be provided in a core plate just like the coolant discharge conduit 8 which is arranged further forwardly or thereabove in FIG. 1. The cooling tube 5 is open both rearwardly where coolant flows upwardly and forwardly from the coolant feed conduit 7 centrally in the direction of the central axis 2 and also at the front at the top where the outlet opening 9 is disposed on the cooling tube 5.

In earlier operating structures cooling water was already introduced through the coolant feed conduit 7 centrally into the cooling tube 5 in an upward forward direction, and urged out of the outlet opening 9 at the front into the mold core 1. As a result the cooling water flows in the annular space 6 in gap form parallel to the central axis 2 of the mold core 1 from the front at the top out of the region of the outlet opening 9 downwardly and rearwardly into the enlarged annular space 6′ in order to be discharged therefrom, outside the cooling tube 5, by way of the coolant discharge conduit 8.

In the new embodiment illustrated here, the inner surface 4 of the mold core 1, in the front surface region 10 of the mold core on which in operation the preform (not shown in the drawing) is injected, is provided with a helical screwthread for forming cooling grooves 11.

The detail II shown on a greatly enlarged scale in FIG. 2 shows the straight lines which are set at a small angle relative to the central axis 2 and which reproduce the cooling grooves 11. The preferred embodiment which is selected here involves cooling grooves 11 of a pointed profile, which extend transversely with respect to the central axis 2 and which extend in a helical configuration. The configuration of the cooling grooves can also be described with a sawtooth screwthread of V-shaped profile, the two side surfaces of which in section represent straight flanks. The section through the wall of the mold core 1 illustrated in FIG. 2 shows that V-shaped profile with the straight flanks.

FIG. 2 also shows the configuration of the outlet opening 9 on the cooling tube 5 at the front thereof. If only that edge of the outlet opening 9 which extends perpendicularly to the central axis 2 and which is identified by reference 12 in FIG. 2 were to be considered, then part of a circle 12 would be seen in a plan view in the direction of the central axis 2. Disposed therebetween are cut-outs 13 with an inclined cut line 14. In other words, the outlet opening 9 on the cooling tube at the front thereof has four cut-outs 13 extending along the cut line 14 in the direction of the central axis 2 (towards same). From the side those cut-outs 13 appear in a V-shaped configuration at the front end beside the outlet opening 9. The cooling tube 5 shown here has four cut-outs 13 distributed uniformly at the periphery of the circle 12, namely two cut-outs disposed in alignment in a direction of view on to the paper in FIG. 2, and two further cut-outs in a direction perpendicular thereto, for which reason FIG. 2 shows at the left the wall 5′ of the cooling tube 5 and thereabove the cut line 14.

In operation cooling water flows through the feed conduit 7 centrally into the cooling tube 5 upwardly and forwardly and issues from the outlet opening 9 at the front, as indicated by the arrow 15 in FIG. 2. As soon as the cooling water has flowed out forwardly over the cut lines 14, it is deflected by the curved inner surface 4 of the mold core 1 along the arrow 16 (FIG. 2) in an arcuate configuration and radially outwardly. The cooling water is now in contact with the inner surface 4 of the mold core 1 and begins to cool it by the intensive contact therewith. The cooling water flows from the front rearwardly parallel to the central axis 2 in the annular space 6 in the form of the gap, that is to say downwardly in FIGS. 1 and 2. On its flow path rearwardly, the cooling water passes the cooling grooves 11 extending transversely with respect to the central axis 2, and experiences a turbulence effect corresponding to the part-circular arrows 17. In that swirled and turbulent condition the cooling water flows further rearwardly (downwardly in FIGS. 1 and 2) in order thereafter to pass into the large annular space 6′ where it is allowed to expand and for it to flow away through the discharge conduit 8.

### LIST OF REFERENCES

1 mold core
2 central axis
3 outer surface of the mold core
4 inner surface of the mold core
5 cooling tube
5′ wall of the cooling tube
6 annular space in the form of a gap
6′ larger rear annular space
7 coolant feed conduit
8 coolant discharge conduit
9 outlet opening
10 front surface region of the mold core
11 cooling grooves
12 edge of the outlet opening
13 cut-outs
14 cut line
15 arrow (direction of flow of the coolant)
16 arrow (direction of flow of the coolant)
17 turbulence direction of the cooling water

What is claimed is:

1. A mold core (1) of an injection molding tool for the injection molding of preforms of plastic material, wherein the mold core (1) is in the form of a hollow casing which is closed at one end, said mold core having a central axis (2), an outer surface (3), an inner surface (4) and a hollow cooling tube (5) which is arranged in the mold core (1) at a spacing from the inner surface (4) thereof, in communication with coolant feed conduits (7) and coolant discharge conduits (8), wherein
the cooling tube (5) extends coaxially with respect to the mold core (1) over almost the entire length thereof and is provided at a downstream end with an outlet opening (9), and
provided on the inner surface (4) of the mold core (1) are cooling grooves (11) extending substantially transversely with respect to the central axis (2).

2. A mold core (1) as set forth in claim 1 characterised in that the cooling grooves (11) are of a pointed, round or mixed pointed and round profile in cross-section.

3. A mold core (1) as set forth in claim 1 wherein the cooling grooves (11) extend in a helical configuration.

4. A mold core (1) as set forth in claim 1 wherein the cooling grooves (11) extend over a surface region (10) of the mold core (1), on which the preform is injected.

5. A mold core (1) as set forth in claim 1 wherein the outlet opening (9) on the cooling tube (5) has at least one cut-out (13) extending in the direction of the central axis (2).

6. A mold core (1) as set forth in claim 2 wherein the cooling grooves (11) extend in a helical configuration.

7. A mold core (1) as set forth in claim 2 wherein the cooling grooves (11) extend over a surface region (10) of the mold core (1), on which the preform is injected.

8. A mold core (1) as set forth in claim 3 wherein the cooling grooves (11) extend over a surface region (10) of the mold core (1), on which the preform is injected.

9. A mold core (1) as set forth in claim 2 wherein the outlet opening (9) on the cooling tube (5) has at least one cut-out (13) extending in the direction of the central axis (2).

10. A mold core (1) as set forth in claim 3 wherein the outlet opening (9) on the cooling tube (5) has at least one cut-out (13) extending in the direction of the central axis (2).

11. A mold core (1) as set forth in claim 4 wherein the outlet opening (9) on the cooling tube (5) has at least one cut-out (13) extending in the direction of the central axis (2).
